(19) United States
(12) Patent Application Publication
(10) Pub. No.: US 2006/0123955 A1
(43) Pub. Date: Jun. 15, 2006

(54) Interchangeable tool heads

(76) Inventor: Yong Hoon Cho, Fullerton, CA (US)

Correspondence Address: Maria Erlinda C. Sarno, Esq., P.O. Box 1023, Artesia, CA, 90702, US

(21) Appl. No.: 11/012,037

(22) Filed: Dec. 14, 2004

(51) Int. Cl. B25B 23/16; B25G 1/04; A46B 9/04

(52) U.S. Cl. 81/177.2; 15/167.1

(57) ABSTRACT

An interchangeable tool head, comprising a handle having a two pronged tip on one end extending from a body of the handle, the two pronged tip parallel to each other and having an inwardly directed lateral tooth at each end; and, a tool head having an etched out track between a top surface and a bottom surface of the tool head, the etched out track having a width matching the distance between the two pronged tip of the handle, a thickness matching the thickness of the two pronged tip of the handle, an inwardly directed lateral etching for accommodating the inwardly directed lateral tooth of the two pronged tip when the handle is engaged with the tool head.

This invention relates to a handle with a configured matching receiver tool heads or tips which allows for interchanging one tool head for another thereby minimizing the number of individual complete tools to own or carry around.

### BACKGROUND

Most tools or instruments at the present time are sold as separate pieces. This results in too many tools or instruments which currently require a tool box, drawers or cabinet to house them. For those whose jobs depended upon these tools, the sheer number of them makes it cumbersome to carry around. This invention can be used with tools or instruments that require different heads or tips but usually have the same or similar handles like the screw drivers, brushes, wrenches, surgical and dental instruments and the like. Although there are numerous applications, illustrated herein is the use of the configured handle and receiver tool head or tips for cosmetic purposes such as those used for cosmetic applications, trimming, shaving and the like. As used herein, tool heads or instrument tips are collectively referred to as tool heads to avoid confusion that may arise when referring to the tips of the handle. Because of the use of one handle for the different heads, this allows for portability and saving of raw materials that would otherwise deplete the natural sources from which the handles are made.

In the application of cosmetics to the eye alone, one uses a lash and brow groomer, eye liner, mascara wand, eye shadow applicator, eye smudge applicator, eye definer sponge, etc. For the face and cheek, several different application brushes are used while for the hair, different length of razors, hair trimmers and tweezers are used. These different tool heads are needed because defining, contouring, blending, camouflaging, enhancing, highlighting, and shadowing, etc. require different tool head characteristics such as softer bristles, thinner tip, stiffer tips, sponge versus brush, comb versus brush, etc. With the claimed invention, the different tool heads are simply configured to engage with the same handle. In usage, the handle simply slides out from one tool head and slide into another tool head. Since only one handle is needed for several cosmetic purpose tool heads, it is easy to carry all the heads all the time, consequently, the unavailability of certain tool heads when needed for certain usage and the inconvenience of carrying numerous individual cosmetic tools are avoided.

Several tools with a universal handle have been used for painting, construction and the like. Most of these have handles having a straight shaft with a cylindrical opening at the top designed to accommodate the tool head having a matching but of a slightly smaller cylindrical bottom that would snugly insert into the top opening of the handle. Alternately, the tool head, instead of the handle will have the hollow cylindrical tube attached to it where the corresponding cylindrical top of the handle will insert into. Others connect the tool head into the top of the handle by using the different screw mechanisms. Since conventional handles are straight providing no flexibility in angling the tool head to the area desired, for more effective applications, some tool heads are angled, sometimes a tool head for every angle desired resulting in more tools to own. Further, in using a straight handle, the user has to employ manual dexterity in using the tool which results in a longer completion time. Also, the handle is usually hard and solid providing less grip.

It is therefor an object of this invention to provide a universal handle able to fit into different tool heads.

It is also an object of this invention to provide a handle that is simple in design.

It is a further object of this invention to provide a handle with greater gripping characteristics.

### SUMMARY

The invention relates to an interchangeable tool head, comprising: a handle having a two pronged tip on one end extending from a body of the handle, the two pronged tip parallel to each other and having an inwardly directed lateral tooth at each end; and, a tool head having an etched out track between a top surface and a bottom surface of the tool head, the etched out track having a width matching the distance between the two pronged tip of the handle, a thickness matching the thickness of the two pronged tip of the handle, and an inwardly directed lateral etching for accommodating the inwardly directed lateral tooth of the two pronged tip when the handle is engaged with the tool head. The tool head can have a tapered edge at the proximal end of the track and a tapered or a reangular edge at the distal end of the track. The body of the handle can be angled downwards, upwards or looped. It is recommended to have the bottom end of the looped handle ergonomically shaped to accommodate an index finger and to be made of a strong but flexible material so it can go along with the pressure exerted by the hand on the handle. With the handle of the claimed invention, the front face of the two pronged tip is the same as its back face thereby making it possible to insert the handle in any direction. The two pronged tip of the handle should have some resiliency to be able to slightly open tip when the tip is inserted around the track of the tool head.

A method for interchanging several tool heads, each tool head having an etched out track between a top and bottom surface and an inwardly directed lateral etching, on a handle having a two pronged tip configured to insert around the track between the top and bottom surface of the tool head and an inwardly directed lateral tooth, comprises the steps of a) inserting the two pronged tip of the handle between the top and bottom surface of the tool head and around the track; b) situating the inwardly directed lateral teeth on the two pronged tip of the handle on a matching inwardly directed lateral etching on the tool head to engage the tool head with the handle; c) slightly pulling on the handle to dislodge the inwardly directed lateral teeth from the inwardly directed lateral etching to release the tool head; d) choosing a replacement tool head; repeating steps a) and b) to situate a different tool head on the handle; and, repeating steps c) and d) to replace the tool head for another tool head.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrtive in nature and not as restrictive.

### BRIEF DESCRIPTION OF THE DRAWINGS

Aspects of the present invention are illustrated by way of example, and not by way of limitation, in the accompanying drawings, wherein:

FIG. 1A is a perspective view of the handle having the configured tip showing how the handle attaches along plane I-I of the tool head.

FIG. 1B is a perspective view of the handle having the configured tip showing an alternate way of attaching the handle along plane I-I to the tool head.

FIG. 1C is a blown up detail of the track on the configured matching tool head where the prongs of the handle enter through to situate and attach with the tool head.

FIG. 2 is a perspective front view of the tip of the handle shown in FIG. 1A.

FIG. 2A is a perspective back view of the tip of the handle shown in FIG. 1A.

FIG. 3 shows the teeth of the handle tips lodging on the inward lateral etchings at the opposite distal sides of the tool head track with the prongs snugly surrounding the track when the handle and the tool head are engaged.

FIG. 3A shows how the handle tips engages with the tool head

FIG. 4 shows another shape of the handle but maintaining the configured tip.

FIGS. 5A-5I is a perspective view of some cosmetic heads used mainly for facial application.

FIG. 6A is a perspective view of a shorter hair trimmer or razor shown with a protective cap for use with more accurate and delicate trimming of the hair such as shaping the eyebrows.

FIG. 6B is a perspective view of a longer hair trimmer or razor shown with a protective cap for use with less accurate trimming of the hair such as trimming the hairs on the armpit or legs.

FIG. 7 is a perspective view of a larger handle and bigger hair trimmer.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any means of interchanging tool heads using the prong and track mechanism of the invention is within the scope of this invention. The detailed description includes specific details to provide a thorough understanding of the claimed invention and it is apparent to those skilled in the art that the claimed invention may be practiced without these specific details. In some instances, well known structures and devices are shown in block diagrams or drawn with broken lines in order to either avoid obscuring the main concepts of the invention or to show the relationship of one part to the other.

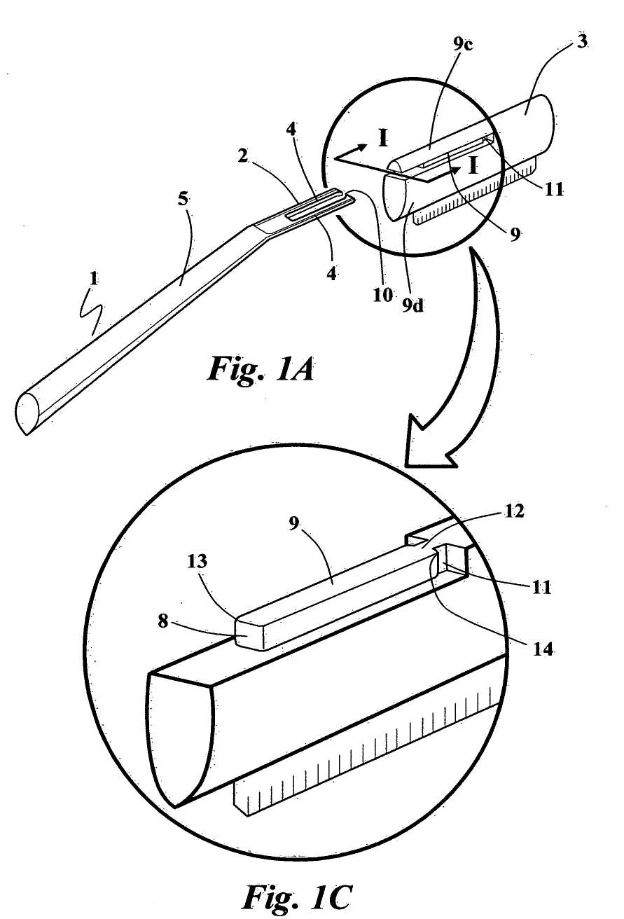

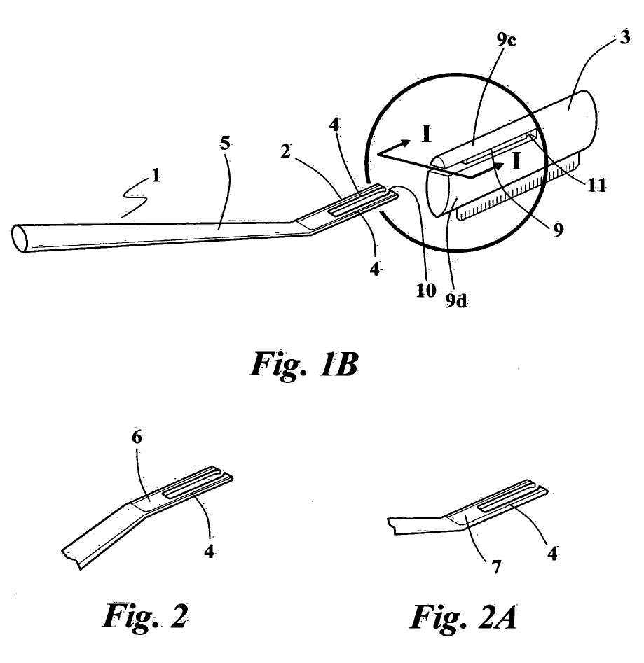

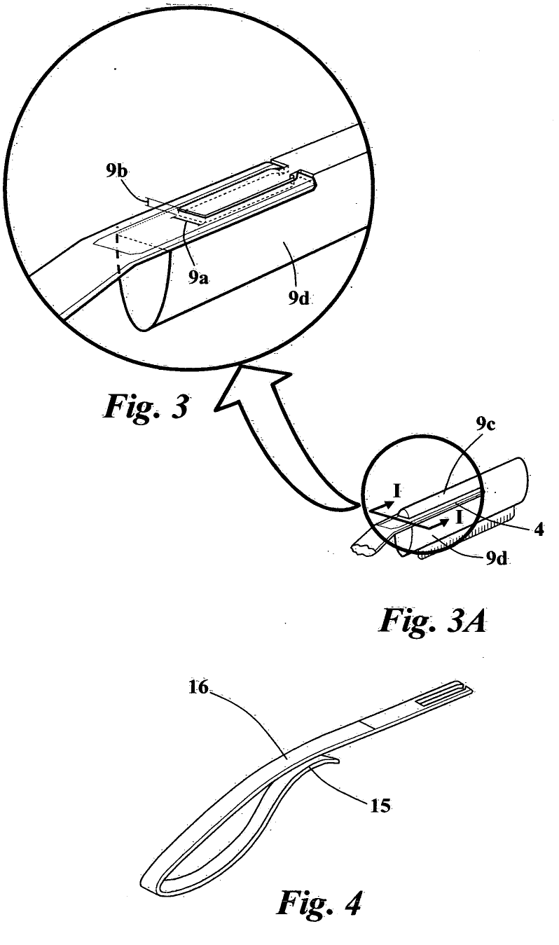

FIG. 1 shows how a handle 1 having a configured connecting tip 2 connects with a configured matching tool head 3. The connecting tip 2 has two prongs 4 parallel to each other similar to a two pronged fork. The body 5 of the handle is recommended to continuously extend downwards at an angle from tip 2 as a single piece instead of connecting the tip 2 to the body 5 by gluing, for example. This avoids the presence of a breakage point on the handle as one uses the different tool heads. The connecting tip of the handle is etched out from the top end of the handle 1 in such a manner that the top face 6 is identical to the bottom face 7 as shown in FIGS. 2 and 2A. This design allows a user to attach the handle in two different manners, one with the handle angling downwards as shown by FIG. 1A and the other way with the handle angling upwards as shown in FIG. 1B. This flexibility will allow two different ways of angling the tool head as the hand grasps at the handle to reach into a desired area of application. In order for the handle to engage with the tool head, the prongs 4 enter a proximal end 8 along a plane I-I of an etched out track 9 on the tool head. FIG. 1C shows a blown up detail of the track 9 with the top surface 9c of the tool head cut off to show how the track is etched out on the tool head. The distance between the two prongs matches the width 9a of the track 9 to result in the prongs snugly fitting around or surrounding the track as shown in FIGS. 3 and 3A. The depth or thickness 9b of the prongs also match the depth or thickness of the track in order to sandwich the prongs of the handle between the top surface 9c and the bottom surface 9d of the tool head 3 as shown in FIG. 3A. To prevent the handle 1 from inadvertently disengaging from tool head 3, that is freely sliding backwards from the track, each of the two prongs have an inwardly directed lateral tooth 10 which would situate at a matching inwardly directed lateral etching 11 carved out from the distal terminal end 12 of the etched out track 9 on the tool head 3 as shown in FIG. 3. The etched out track 9 is recommended to have a tapered or rounded edge 13 at its proximal end 8 and a tapered or rounded edge 14 at its distal end 12 to facilitate the entrance to and exit of the handle from the tool head as the user changes from one tool head to another. The distal end of the track can also be plain rectangular without tapering or rounding the edges if the depth of the etching 11 is not so much as to disallow the teeth 10 from disengaging and exiting track 9. As used herein, the proximal end is the end facing the tip 2 of the handle as it enters track 9 while the distal end is the end inside the tool head where the track terminates. The material from which the handle is made is important. It can be made of plastic or metal. It is recommended for the handle to be solid to provide strength but at the same time confer some form of resiliency on the prongs 4 so that it can slightly open up as it enters the track and revert back to its original shape when the teeth 10 lodges on the lateral etching 11.

The body 5 of the handle is recommended to be at an angle as shown in FIGS. 1A and 1B. However, the shape of the body is not confined to this configuration. It can assume different shapes. For example, it can be looped with the bottom end 15 of the loop ergonomically shaped to accommodate the index finger with the top 16 of the loop opposite the bottom end 15 accommodating the thumb as the hand grips on the handle while using the tool head. FIG. 4 shows this looped handle. With a looped handle, the material must be strong but flexible so it can go along with the grip of the hand. Thin strips of metal such as those made from stainless steel, titanium or aluminum alloys are examples that can be used.

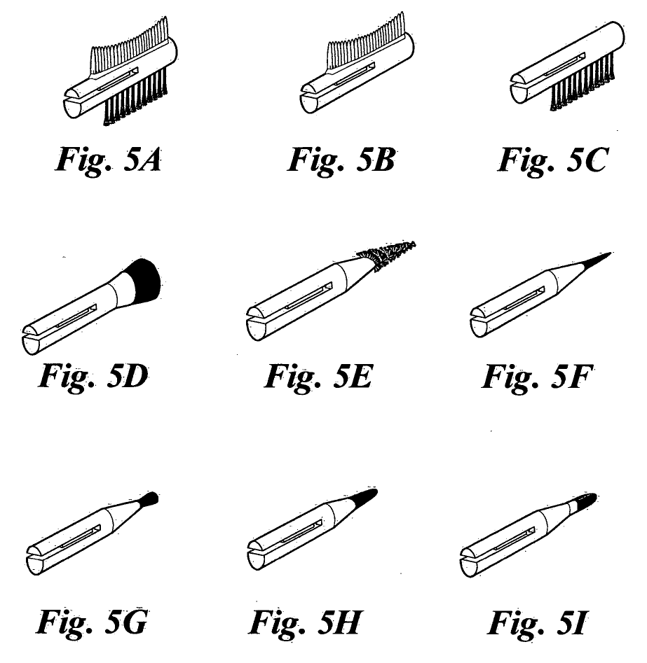

Any tool head of any size and function having the etched out track matching the two pronged tip of the handle can be used. FIGS. 5A-5I show different cosmetic tool heads typically used for facial applications. FIG. 5A is a lash and brow groomer having a comb in combination with a brush. FIG. 5B is a comb tool head while FIG. 5C is a brush tool head. FIG. 5D is a circular brush tool head while FIG. 5E shows a mascara wand tool head. FIG. 5F is an eyeliner head, 5G an eyeshadow head and 5H and 5I are sponge applicator heads that can also be used to define the eyes or remove smudges. With just these tools for facial application, one can imagine how much space is required to store these 9 different tools at a time plus all other tools for other purposes or how cumbersome it is to be bringing all these around which is what make-up artists or others do. As these tools wear out, having more pieces to throw will likewise fill the dump sites faster.

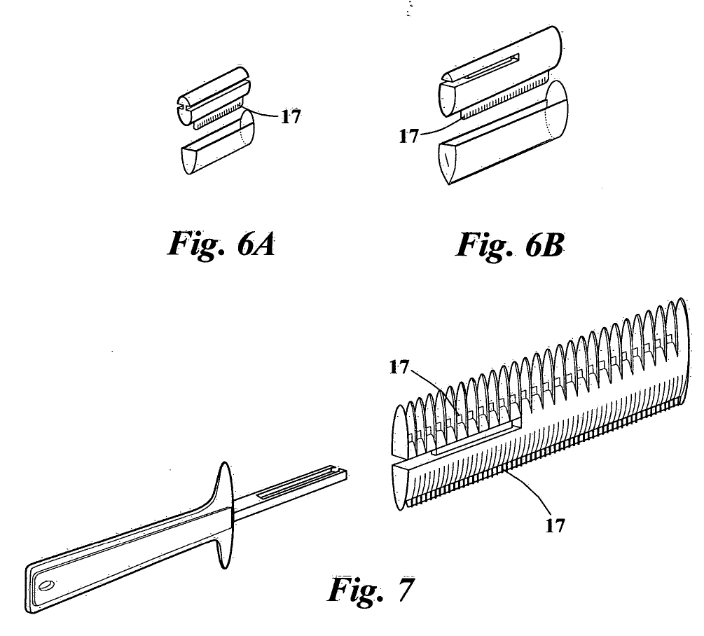

A good application for these interchangeable tool heads is to replace the current disposable razors. With the present disposable razors, the blades 17 on these razors easily dull out, consequently, the whole razor is thrown out and a new razor is used. This is the reason why there are several disposable razors in a pack. With the claimed invention, one only has to replace the blades when it becomes dull while keeping the handle thereby minimizing the depletion of the raw materials from which the handles are made, reducing the cost to manufacture and lessening the materials dumped at the dump sites which in this case are non-biodegradable. FIG. 6A shows the short, usually 10 mm in length, and FIG. 6B shows the long, usually 30 mm in length, razor heads for hair trimming. With this handle, one can easily switch from a short to a long razor head according to the desired usage. The short razors are usually used for delicate and accurate trimming of the hair such as in the shaping of the eyebrows. The longer hair trimmers are for trimming the hair at the armpit or legs. With this, one does not have to bring two separate razors but only one handle with two different heads are enough. The same handle but of a larger size can be used for larger tool heads such as the trimmer illustrated in FIG. 7 which is used for cutting and trimming the hair on the head so long as the tool head is configured to accommodate the handle 1.

Another advantage is the flexibility to pick and choose only those tool heads that one anticipates to need at a particular time for different applications. For example, one does not shape the eyebrows everyday or may not need to apply mascara or eye liner. Also, because of the portability resulting in requiring only one handle, it is easy to bring different tool heads for different applications. It should be noted, however, that small too heads require small handles while large tool heads will require a larger handle.

These interchangeable tool heads can be compactly stored in a container when not in use or in transporting. It is recommended to have a separate holder for each tool head and a separate holder for the handle. There are prior art patents on containers or pouches whose concepts and design can be easily adapted for these interchangeable tool heads.

To interchange one tool head with another, one simply applies a slight pull on the handle to dislodge the teeth 10 of the tips 2 from the etchings 11 of the tool head 3 and slide out the undesired tool head. Once the undesired tool head is disengaged from the handle, the desired tool head is chosen and engaged with the handle by slipping or sliding the prongs 4 of the handle into the track 9 on the tool head until the teeth 10 of the handle lodges on the etchings 11 of the desired tool head 3.

While the embodiments of the present invention have been described, it should be understood that various changes, adaptations, and modifications may be made therein without departing from the spirit of the invention and the scope of the claims.

I claim:

1. An interchangeable tool head, comprising:
a handle having a two pronged tip on one end extending from a body of the handle, the two pronged tip parallel to each other and having an inwardly directed lateral tooth at each end; and,
a tool head having an etched out track between a top surface and a bottom surface of the tool head, the etched out track having a width matching a distance between the two pronged tip of the handle, a thickness matching a thickness of the two pronged tip of the handle, an inwardly directed lateral etching for accommodating the inwardly directed lateral tooth of the two pronged tip when the handle is engaged with the tool head.

2. The interchangeable tool head of claim 1 wherein the body of the handle extends downwards at an angle.

3. The interchangeable tool head of claim 1 wherein the body of the handle extends upwards at an angle.

4. The interchangeable tool head of claim 1 wherein a front face of the two pronged tip is the same as the back face of the two pronged tip.

5. The interchangeable tool head of claim 1 wherein the etched out track has a tapered edge at its proximal end and a tapered edge at its distal end.

6. The interchangeable tool head of claim 1 wherein the etched out track has a rectangular distal end.

7. The interchangeable tool head of claim 1 wherein the two pronged tip of the handle has resiliency to slightly open when inserted to the track of the tool head.

8. The interchangeable tool head of claim 1 wherein the handle is looped with a bottom end ergonomically shaped to accommodate an index finger.

9. The interchangeable tool head of claim 8 wherein the looped handle is of a strong but flexible material.

10. A method for interchanging several tool heads, each tool head having an etched out track between a top and bottom surface and an inwardly directed lateral etching, on a handle having a two pronged tip configured to insert around the track between the top and bottom surface of the tool head and an inwardly directed lateral tooth, comprising:
a) inserting the two pronged tip of the handle between the top and bottom surface of the tool head and around the track;
b) situating the inwardly directed lateral teeth on the two pronged tip of the handle on a matching inwardly directed lateral etching on the tool head to engage the tool head with the handle;
c) slightly pulling on the handle to dislodge the inwardly directed lateral teeth from the inwardly directed lateral etching to release the tool head;
d) choosing a replacement tool head;
e) repeating steps a) and b) to situate a different tool head on the handle; and,
f) repeating steps c) and d) to replace the tool head for another tool head.
